(19) United States
(12) Patent Application Publication
(10) Pub. No.: US 2019/0291263 A1
(43) Pub. Date: Sep. 26, 2019

(54) FOLDING WORKBENCH

(71) Applicant: STANLEY BLACK & DECKER, INC., New Britain, CT (US)

(72) Inventors: Joshua FULLER, Towson, MD (US); Roger PALMER, Towson, MD (US); Yosi SABBAG, Rosh Ha'Ayin (IL); Elad SHITRIT, Rosh Ha'Ayin (IL)

(21) Appl. No.: 16/439,217

(22) Filed: Jun. 12, 2019

Related U.S. Application Data
(63) Continuation of application No. 16/195,731, filed on Nov. 19, 2018.
(60) Provisional application No. 62/587,994, filed on Nov. 17, 2017.

(51) Int. Cl. B25H 1/04; B25H 1/12

(52) U.S. Cl. CPC B25H 1/04; B25H 1/12

(57) ABSTRACT

The invention can be a fold down bench that can allow a user to have a storage space for tools as well as a work surface. The unit can be mounted to a wall by a first member and the worksurface, second member can be pivotably connected to the first member. In the closed position the bench can also be able to be latched closed. A pegboard is included so that a user can store tools or equipment. The first and second members include support ends adapted to engage with the support end of the other member for structural support.

The present application is a continuation of U.S. patent application Ser. No. 16/195,731 filed on Nov. 19, 2018, which claims priority to U.S. Provisional Patent Application No. 62/587,994, filed Nov. 17, 2017. The foregoing applications are incorporated by reference in their entirety.

### I. FIELD OF THE INVENTION

The present invention relates to workbenches, and more particularly to folding workbenches.

### II. BACKGROUND OF THE INVENTION

People across various industries and homes engage in industrial and craft activities requiring a work space and storage for storing tools and supplies for these activities. Unfortunately, many spaces do not have adequate space and users result to using available work surfaces such as desks or tables to engage in these activities. Using inappropriate spaces can damage the temporary work station. These temporary workstations do not provide proper storage for tools. Moreover, use of these temporary workstations can cause a mess and pose danger to pets and/or children.

There now exists a need for convenient apparatus and system for providing a space saving workstation for technicians using a plurality of tools and a storage area for storing such tools. The present work stations in this technology space for using or storing such tools are usually not capable of providing rigid stability and additional storage capability. Thus, there remains a need for an improved folding workbench providing additional storage support.

### III. SUMMARY OF THE INVENTION

One object of the present invention is to provide a mounted workbench that is pivotable from a vertical position to a horizontal position and provides storage capability for a number of tools. The invention is directed toward wall mounted structures that can project out from a wall and can swing or pivot from a horizontal position to one or more raised positions and includes brackets that can be affixed onto the workbench into one or more of the raised positions. The brackets can be fixed onto the back of the invention in a singular layout. In at least one embodiment the workbench can be independent of mounting against a wall and can be a supported by a plurality of supporting legs.

In at least one embodiment, the workbench can be a fold down bench that can allow a user to have a storage space for tools as well as a work surface. The workbench can be mounted to a wall or vertical structure. In the closed position, a table/workstation can be latched closed. When the bench is opened to the workbench position, the mounted panes can interact with sides of the table to prevent the table from rotation further and provide support. The table, e.g. work surface, and mounted back can having opposing profile cups to allow even weight distribution and a limiting range of motion of the work surface. It can also ensure alignment and reduce deflection at a front edge. The front profiles can also as a reinforced clamping profile. The workbench can include a number of pegboards such as the pegboard affixed to the mounting bracket and can include pegboards in other areas, such as the inner sides of the support arms, so that a user's can store tools or equipment in an easily acquirable manner.

In one embodiment, the present invention provides a mounted workbench comprising a first structure member configured to be affixed to a vertical structure, a second structure member, wherein the second structure member is configured to be pivotably connected to the first structure member from one of a vertical position to a substantially horizontal position or a substantially horizontal position to a vertical position, a locking element adapted to couple the second structure member to the first structure member, a plurality of panes of the first structure member adapted to engage with at least part of the plurality of panes second structure member to prevent continued rotation of the second structure member.

In another embodiment, the present invention provides a folding workbench comprising a first support member, the first support member configured to be mounted vertically, a second support member, the second support member configured to be pivotably fixed to the first support member in vertical placement and pivotable from the first support member in a horizontal placement, a storage compartment, the storage compartment located in a bottom portion of the first support member, a plurality of mounting brackets, the plurality of mounting brackets configured to provide rigid stability of the first vertical member; and a pivotable hinge, the pivotable hinge adapted to move the second support member from a vertical state to a substantially horizontal state or a substantially horizontal state to a vertical state.

In another embodiment, a work bench comprising a first support member, the first support member configured to be mounted vertically, a second support member, the second support member configured to be attachable to the first support member in vertical placement and wherein the second support member is pivotably connected to the first support member, a plurality of support ends, the adapted to cover the distal ends of the first and second support members, a hinge, the hinge coupling the second support member to the first support member from one of a substantially horizontal position or a substantially horizontal position to a vertical position, a storage compartment, the storage compartment located in a bottom portion of the first support member, a plurality of mounting brackets, the plurality of mounting brackets configured to couple the first support member to a vertical structure.

In yet another embodiment, the present invention includes a work bench for storing a number of tools, the work bench comprising: a first support structure, the first support structure configured to be mounted vertically; a second support structure, the second support structure configured to be attachable to the first support structure in vertical placement and pivotable from the first support structure in a horizontal placement; a storage compartment, the storage compartment located in a bottom portion of the first support structure; a plurality of mounting brackets, the plurality of mounting brackets configured to provide rigid stability of the first vertical member; and a pivotable hinge, the pivotable hinge adapted to move the second support structure to a number of different positions from a vertical state to a horizontal state.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the root terms “include” and/or “have”, when used in this specification, specify the presence of stated features, steps, operations, elements, and/or components, but do not preclude the presence or addition of at least one other feature, step, operation, element, component, and/or groups thereof.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus.

For definitional purposes and as used herein, “connected” or “attached” includes physical or electrical, whether direct or indirect, affixed or adjustably mounted. Thus, unless specified, “connected” or “attached” is intended to embrace any operationally functional connection.

As used herein, “substantially,” “generally,” “slightly” and other words of degree are relative modifiers intended to indicate permissible variation from the characteristic so modified. It is not intended to be limited to the absolute value or characteristic which it modifies but rather possessing more of the physical or functional characteristic than its opposite, and approaching or approximating such a physical or functional characteristic.

In the following description, reference is made to the accompanying attachments and drawings which are provided for descriptive and illustration purposes as representative of specific exemplary embodiments in which the invention may be practiced. Given the following description of the specification and drawings, the apparatus, methods, and systems should become evident to a person of ordinary skill in the art. Further areas of applicability of the present teachings will become apparent from the description and illustrations provided herein. It is to be understood that other embodiments can be utilized and that structural changes based on presently known structural and/or functional equivalents can be made without departing from the scope of the invention.

### IV. DESCRIPTION OF THE DRAWINGS

The above-mentioned and other features, embodiments, and advantages of this invention, and the manner of attaining them, will become more apparent and the invention will be better understood by reference to the following descriptions of embodiments of the invention taken in conjunction with the accompanying drawings, wherein:

FIG. 1 illustrates one embodiment of the folding workbench.

FIG. 2 illustrates a front view of the bottom of a support member of the folding workbench of FIG. 1.

FIG. 3 illustrates a perspective view of the folding workbench of FIG. 1.

FIG. 4 illustrates a side view of the folding workbench affixed to an external wall.

FIG. 5 illustrates a partial view of the mounting mechanism of FIG. 4.

FIG. 6 illustrates a side view of the internal composition of the second support member.

FIG. 7 illustrates a perspective, cutaway view of the folding workbench.

FIG. 8 illustrates a side, cutaway view of the folding workbench.

FIG. 9 illustrates a side, cutaway view of the support ends of the folding workbench.

FIG. 10 illustrates a perspective view of the support ends of FIG. 9.

FIG. 11 illustrates a perspective view of the hinge of the folding workbench.

FIG. 12A-12B illustrates perspective views of alternate embodiments of the folding workbench.

Corresponding illustrated images indicate corresponding parts throughout the several views of the present invention. The exemplifications set out herein illustrate embodiments of the present invention, and such exemplifications are not to be construed as limiting the scope of the present invention in any manner.

These and other features of the invention will become apparent upon review of the following description of the presently preferred embodiments of the invention, taken into conjunction with the figures.

### V. DESCRIPTION

A detailed description of apparatuses, methods, and systems, consistent with embodiments of the present disclosure is provided below. While several embodiments are described, it should be understood that the disclosure is not limited to any one embodiment, but instead encompasses numerous alternatives, modifications, and equivalents. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure.

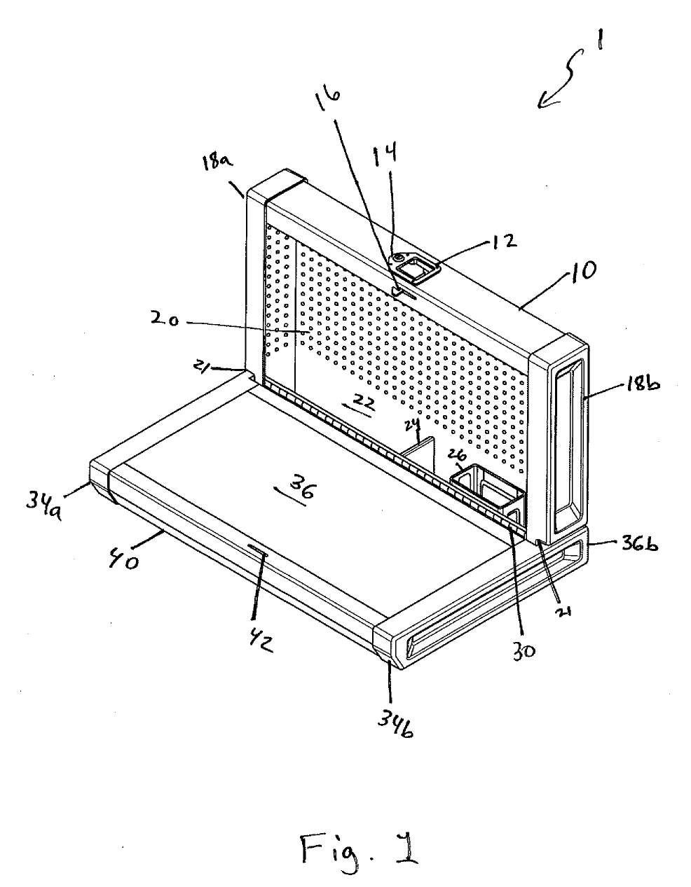

Referring to FIG. 1 there is one embodiment of a fold down storage workbench 1. The folding workbench 1 can include a stationary, first support member 10 and a second support member 40 that are pivotably hinged together. The first support structure or member 10 can be mounted or affixed to a vertical structure, such as a wall, and the second support structure or member 40 can be coupled or attached to the first support member by a hinge 30. The coupling or attachments means may include bolting, screwing, or affixing one end of a support member to a leaf of the hinge 30. The first support member 10 and second support member 40 can be fastened or attached to at least one part of the first support member by a fastening element or lock and latch assembly 12 that includes hooks, latches, key and lock, adhesive, pins, knobs, magnet assemblies, etc.

The first support member 10 in FIG. 1 includes a back wall 20, a storage compartment 22, and first support ends 18a, 18b. The back wall 20 can be homogenous or a heterogenous construction such as a pegboard wall. The storage compartment 22 can be a plurality of spaces or chambers and can be configured to include an optional divider 24 to create a plurality of storage compartments 22. The storage compartment 22 can hold small parts, such as screws, bolts, nuts, tool bits or hand tools. The storage compartment 22 can include drains configured to allow liquids to channel out and still retain screws, bolts, nuts, and tool bits. The storage compartment 22 can also receive a detachable bin 26 that can hold small parts, such as screws, bolts, nuts, or tool bits. The detachable bin 26 can be slotted or snapped into the storage compartment 22 for secure placement. The first support ends 18a, 18b are molded in shape to provide additional structural support and are placed onto an outer surface of the support ends 18a, 18b of the first support member 10. The first support ends 18a, 18b also includes partially recessed ends 21 at the bottom of each support ends 18a, 18b for receiving part of the second support member 40.

The pegboard can be included as an outer surface of the back wall 20 of the first member 10 that is vertically mounted. A pegboard can also be placed on a number of outer or inner surfaces of the first support member 10 and/or the second, pivotable support member 40, such as a pegboard along the two inner, parallel side walls of the first support member 10 or a pegboard on the two outer, parallel side walls of the second support member 40. The second support member 10 can also include a number of fastener elements on its underside, such as a track system or track wall, adapted to hold a plurality of tools.

The pegboard can be made of any suitable material configured for adding latching elements that are adapted to store one or more tools. The pegboard can include a number of attachment receiving elements to hold or fasten at least one tool to the pegboard. Although a pegboard is described for holding attaching at least one tool to the pegboard, any suitable structure, such as a track system, track wall, or a plurality of shelfs placed in between the first support member, can be used for attaching a plurality of tools, trays, bins, or accessories.

The second support member 40 shown in FIG. 1 includes a flat upper surface 36, second support ends 34a, 34b, and an opening 42. The flat upper surface 36 is illustrated to be a flat surface to allow work and maintain mechanical labor upon it. The flat upper surface 36 can also be used as a desk. In this embodiment, a section of the second support ends 34a, 34b are extended 36a, 36b for placement below the partially recessed ends 21 of the first support member 10 to provide additional support structure and reinforcement. The support ends can be described as mounted panes. The bottom of the second support member 40 is configured to handle cantilever movement. FIG. 1 also illustrates the first support member 10 having a lock and latch assembly 12 as a locking element. The lock and latch assembly 12 can include a lock 14 that is operatively connected to a latch hook 16 for engaging and securing the second support member 40 to the first support member 10 when the second support member 40 is placed in a vertical, parallel position to the first support member 10. The opening 42 in the second support member 40 is located at the end furthest from the back wall 20 of the first support member 10. The opening 42 is adapted to receive the latch hook 16 and securely couple the second support member 40 to the first support member 10.

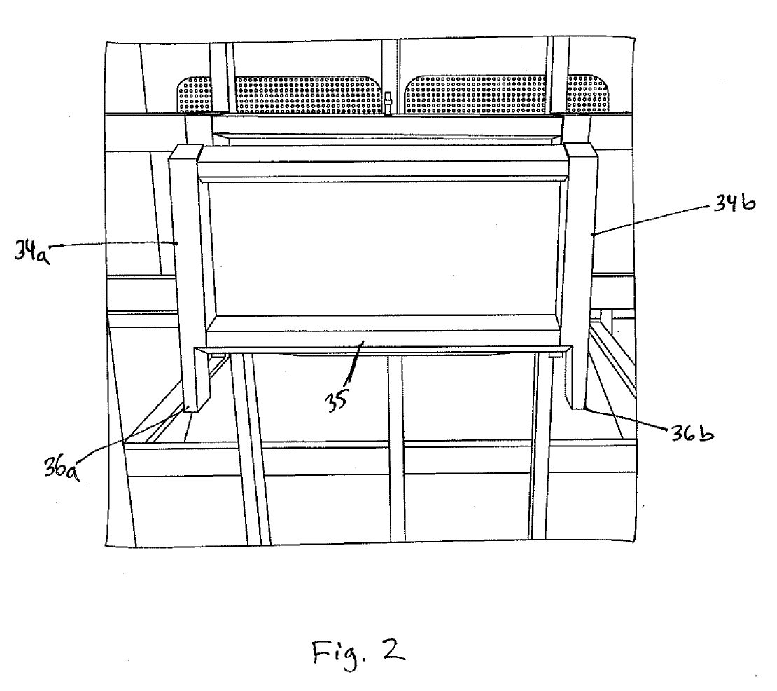

FIG. 2 illustrates the folding workbench 1 with the second support member 40 in vertical, parallel placement coupled to the first support member 10. The second support member 40 is illustrated as hollow on the bottom and surrounding by the support ends 34a, 34b and a back support end 35. As shown in FIG. 2, the extended arms 36a, 36b of the second support member 40 protrudes downward past the bottom axis of the first support member 10 when the second support member is in vertical position. In this embodiment, the bottom of the second support member 40 can include attachment members, such as pegboard, tracks, closable bins, or forms to hold tools in either vertical or horizontal position for additional storage.

The fold down or pivoting workbench 1 can be pivoted downward from a vertical arrangement to a substantially horizontal arrangement, such as between 1 and 90 degrees. The pivotable, second support member 40 can swing or pivot down from a vertical, parallel placement to a horizontal perpendicular placement by disengaging the lock and latch assembly 12 in the first support member 10 from the opening 42 in the second support member 40.

When the folding bench 1 is opened to the workbench position (e.g. the second support member moved into 90 degree horizontal position), the mounted panes or support ends (e.g. the recess ends 21 of the first support member 10 and the extended ends 36a,36b of the second support member 40) can interact with the sides of the table to prevent the table from further rotation and provide support to the first support member 10. The table/workstations and mounted back can having opposing profile cups to allow even weight distribution and a limiting range of motion of the work surface. Each outer surface side of each support ends can include a number of recesses or indentations.

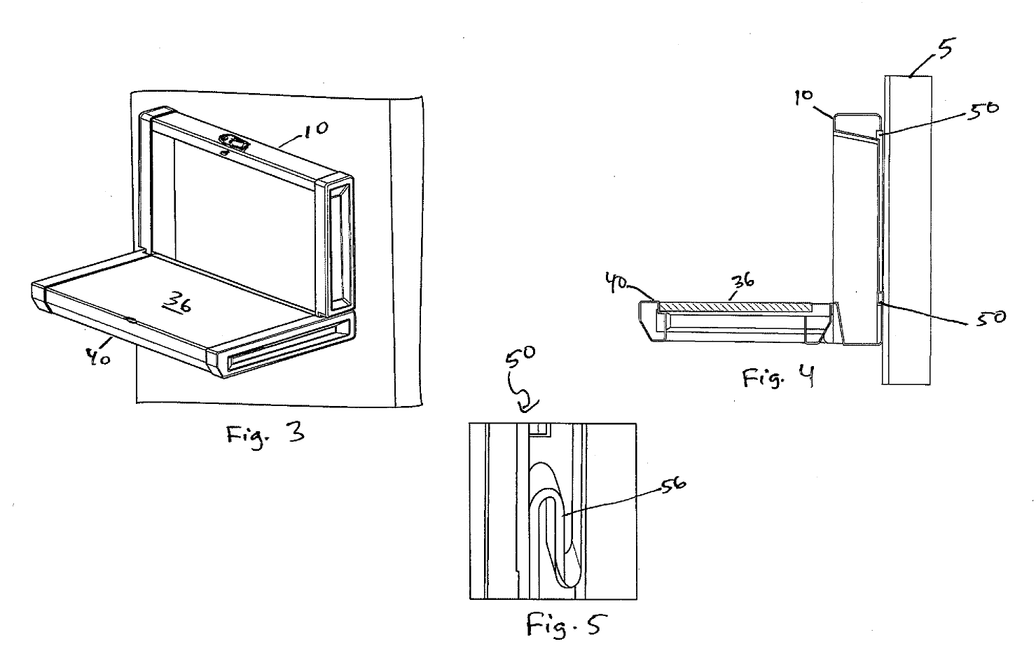

FIG. 3 illustrates a perspective view of the folding workbench 1 without a pegboard. As shown, the second support member 40 is in a horizontal 90 degree arraignment from the first support member 10. FIG. 4 illustrates a side view of the folding workbench 1 coupled to an external structure, such as a wall 5. The workbench 1 is coupled to the wall 5 by mounting brackets 50. The mounting brackets 50 can be located at one upper end and one lower end of the first support member 10 to provide two levels of stability of the first support member 10 to the wall 5. The first support member 10 can be fastened to the mounting brackets 50 by bolting the pegboard through holes onto the mounting bracket 50, such as by screw, bolt, nut, or suitable fastening mechanism.

FIG. 5 shows a close-up, partial view of mounting bracket of FIG. 4. The mounting brackets 50 can be any suitable bracket for mounting the workbench 1 onto a vertical structure, e.g. wall 5, but in this embodiment the brackets 50 are approximately J-Shaped brackets 56 for easy latching into other brackets and providing an attaching mechanism that produces additional stability of the workbench. An advantage of the J shape brackets 56 are the brackets cups and secures the other J shaped bracket 56, pulling it closer, whereas other brackets, e.g. French cleats, act as a level and can be more easily damaged or knocked free.

The J-Shaped brackets 56 can be a composite construction or material makeup, such as comprising a heterogeneous mixture of metal, wood, and/or a type of plastic. In at least one embodiment, the brackets are metal. The brackets 56 can also be made of engineered plastic, (e.g. polypropylene, Acrylonitrile Butadiene Styrene (ABS), Nylon, etc.), such as glass filled for creep and temperature resistance. The load bearing of the J-Shaped brackets 50 include an increase capacity as in comparison to many other brackets. The structural configuration, composite material make-up of the frame, and/or the J-shaped brackets 56 can increase a standard load bearing capacity from 18 kg up to approximately 500 kg. The mounting bracket 50 can include metal members fitting into plastic members by snap fit, adhesive, screws, etc. or the inverse. In an alternate embodiment, the brackets 56 can be adapted for male-to-female arrangement to provide load bearing capacity.

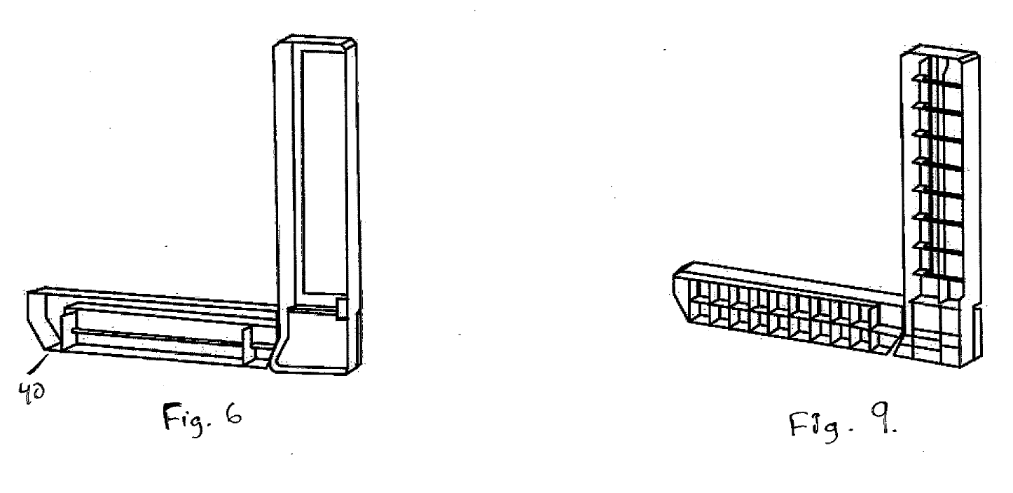

FIG. 6 illustrates a side view of the internal composition of the second support member 40 without the second support ends 34a,34b. This bottom of the second support member or ends is shown to have open space that can be used to configure additional storage on the bottom of the support member, such as tracks, closable bins, or forms to hold tools in either vertical or horizontal position.

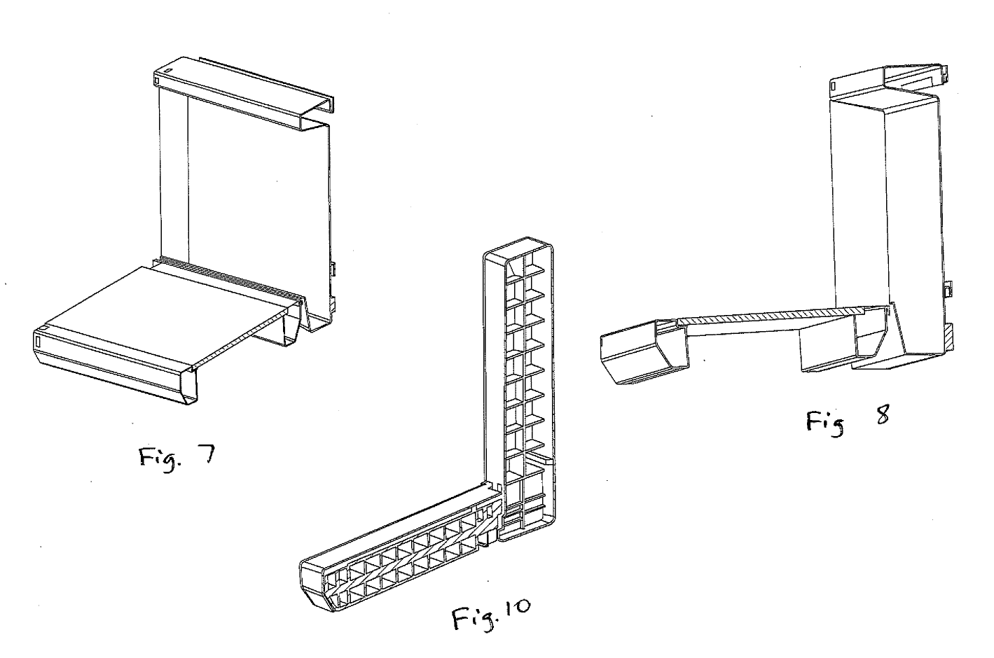

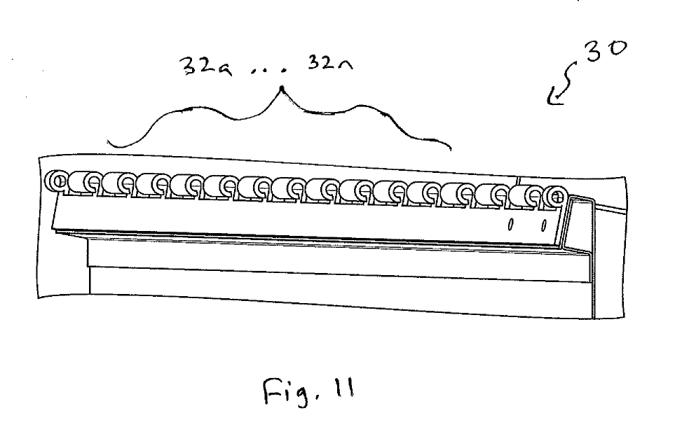

FIGS. 7 and 8 illustrate perspective cutaway views of the folding workbench 1. The open profile of the workbench 1 is illustrated to show the first 10 and second support member 40 without the support ends. FIGS. 9 and 10 illustrates cutaway views of the folding workbench 1 with the support ends 18a,18b,34a,34b. The folding workbench 1 can include a number of structural configurations that support the workbench 1 in a variety of positions. The workbench 1 can incorporate a structural rib construction in the sides of the support ends 18a, 18b, 34a,34b, e.g. for providing additional stability. The rib construction can include structural cross sections for greater stiffness and load bearing capacity/rigid stability. The cross sections can be a predetermined thick or thin measurement to increase or decrease load bearing capacity. As shown in FIG. 10, the non-limiting the structural configuration of the support ends can be “x”, square, diamond or honey comb configuration to provide improved stability and/or to increase load bearing capacity.

FIG. 11 illustrates a perspective view of the hinge 30 of the folding workbench 1. The hinge 30 is configured as a continuous hinge to be coupled along the bottom axis of first support member 10 and the top axis of the second support member 40. The hinge knuckles 32a . . . 32n can be coupled to the support members by a pin or plurality of rivet pins. In this embodiment the number of knuckles, such as the illustrated 16 hinge knuckles in the workbench, provides the additional benefit and support of distributing weight placed on the second support member onto across the knuckles 32a . . . 32n. The number and size of the pins can be any number adapted to be coupled to the support members. FIG. 6 shows an open hinge 30 that may be coupled to the members such as by a 1.5 mm pin or a plurality of 1.5 mm pins. An increase in the number of knuckles and the smaller the size of the knuckles can allow for more even weight distribution and support on of the second support member. Each knuckle 32a . . . 32n on the hinge may have a concentrated body and an opening on either end for doubling up pins and continuous support and weight distribution.

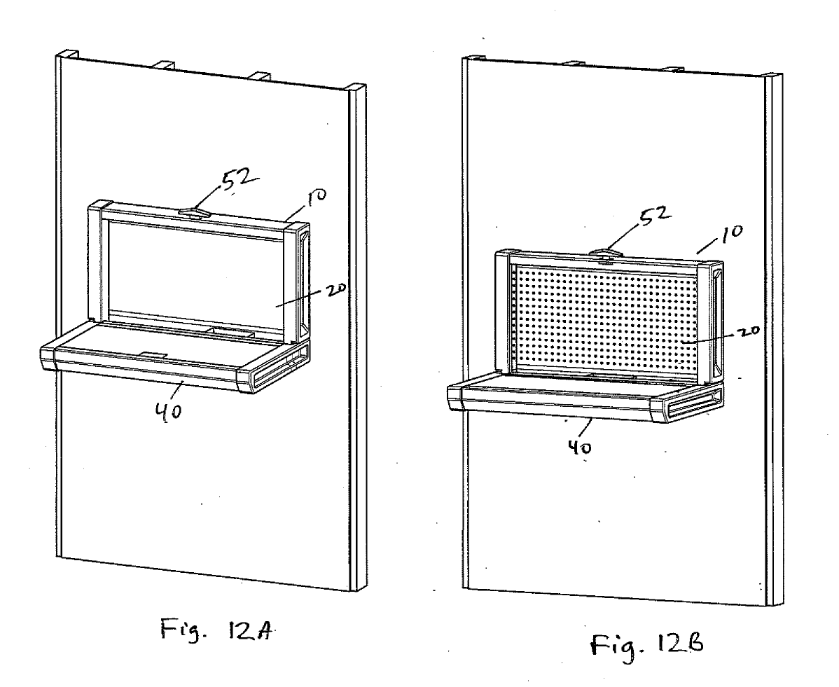

FIG. 12A-12B illustrates perspective views of alternate embodiments of the folding workbench 1. FIG. 12A illustrates the folding workbench 1 having a pull latch 52 at the top of the first support member 10. The pull latch 52 is shown atop of a workbench 1 with a backwall 20 not including pegboard. FIG. 13B illustrates the folding workbench 1 having a pull latch 52 at the top of the first support member 10 and a backwall 20 with a pegboard. In FIGS. 12A-12B, the pull latch 52 acts in place of the lock and latch assembly 12. In this embodiment, the top of the pull latch 52 is a locking element and can include a lock 14 operable with a key for engaging the latch hook 16 into the opening 42 of the second support member 40 for securement to the first support member 10.

In various embodiments, the folding workbench 1 frame can be made of a composite construction or material makeup, such as comprising a heterogeneous mixture of metal, wood, fiberboard and/or plastic. The frame can also be a homogenous mixture of metal, wood, and/or plastic. The workbench 1 frame can also be made of engineered plastic, (e.g. polypropylene, Acrylonitrile Butadiene Styrene (ABS), Nylon, etc.), such as glass filled for creep and temperature resistance. In another embodiment, the workbench can include a number of electrical outlets for providing a power source to at least one tool.

In an alternate embodiment of a fold down storage workbench 1, the second support member 40 is pivotable from the first, mounted member 10 and can be supported by a plurality of legs 62 (not shown) when the second support member 40 is in horizontal placement. The plurality of legs 62 can be affixed to the either the side walls or support ends 34a, 34b of the second support member 40 or underneath the second support member 40 to provide additional stability to the workbench.

In various embodiments, the terms support member, structure member, and support structure can be interchangeable and the equivalent.

The example and alternative embodiments described above may be combined in a variety of ways with each other. It should be noted that the present invention may, however, be embodied in many different forms and should not be construed as limited to the embodiments set forth herein; rather, the embodiments set forth herein are provided so that the disclosure will be thorough and complete, and will fully convey the scope of the invention to those skilled in the art. Furthermore, the steps and number of the various steps illustrated in the figures may be adjusted from that shown. The accompanying figures and attachments illustrate exemplary embodiments of the invention.

Although the present invention has been described in terms of particular example and alternative embodiments, it is not limited to those embodiments. Alternative embodiments, examples, and modifications which would still be encompassed by the invention may be made by those skilled in the art, particularly in light of the foregoing teachings.

Those skilled in the art will appreciate that various adaptations and modifications of the example and alternative embodiments described above can be configured without departing from the scope and spirit of the invention. Therefore, it is to be understood that, within the scope of the appended claims, the invention may be practiced other than as specifically described herein.

We claim:

1. A mounted workbench comprising:
a first structure member configured to be affixed to a vertical structure;
a second structure member, wherein the second structure member is configured to be pivotably connected to the first structure member from one of a vertical position to a substantially horizontal position or a substantially horizontal position to a vertical position;
a locking element adapted to couple the second structure member to the first structure member; and
a plurality of panes of the first structure member adapted to engage with at least part of a plurality of panes of the second structure member to prevent continued rotation of the second structure member.

2. The mounted workbench of claim 1, wherein the plurality of panes contains a rib structure.

3. The mounted workbench of claim 2, wherein the rib structure is one of a diamond or honeycomb configuration to provide additional strength.

4. The mounted workbench of claim 1, wherein the plurality of panes in the second structure member is affixable to the recess of the plurality of panes of the first support member.

5. The mounted workbench of claim 1, wherein the plurality of panes of first structure member is receivable to the plurality of panes of the second structure member.

6. The mounted workbench of claim 1 further comprising a hinge, wherein the hinge includes a plurality of knuckles configured to distribute weight on the second structure member.

7. The mounted workbench of claim 1 furthering comprising a storage chamber located at the bottom of the first structure member, wherein the storage member includes a number of drains for liquid removal.

8. A folding workbench comprising:
a first support member, the first support member configured to be mounted vertically;
a second support member, the second support member pivotable from the first support member;
a storage compartment, the storage compartment located in a bottom portion of the first support member;
a plurality of mounting brackets, the plurality of mounting brackets configured to provide rigid stability of the first support member; and
a hinge, the hinge adapted to move the second support member from a vertical state to a substantially horizontal state or a substantially horizontal state to a vertical state.

9. The folding workbench of claim 8 further comprising a plurality of support ends, the support ends adapted to cover the distal ends of the first and second support members.

10. The folding workbench of claim 9, wherein the support ends contain a rib structure, the rib structure being one of a diamond or honeycomb configuration.

11. The folding workbench of claim 8, wherein the second support member includes a plurality of support ends affixable to the recess of the support ends of the first support member.

12. The folding workbench of claim 8, wherein the first support member includes a plurality of support ends receivable to the support ends of the second support member.

13. The folding workbench of claim 8 further comprising a hinge, wherein the hinge includes a plurality of knuckles configured to distribute weight on the second support member.

14. A work bench comprising:
a first support member, the first support member configured to be mounted vertically;
a second support member, wherein the second support member is pivotably coupled to the first support member and configured to be attachable to the first support member in vertical placement;
a plurality of support ends, the adapted to cover the distal ends of the first and second support members;
a hinge, the hinge coupling the second support member to the first support member from one of a substantially horizontal position or a substantially horizontal position to a vertical position;
a storage compartment, the storage compartment located in a bottom portion of the first support member; and
a plurality of mounting brackets, the plurality of mounting brackets configured to couple the first support member to a vertical structure.

15. The folding workbench of claim 14, wherein the plurality of support ends contains a rib member, the rib member being one of a diamond or honeycomb configuration.

16. The folding workbench of claim 14, wherein the storage chamber includes a number of drains for liquid removal.

17. The folding workbench of claim 14, wherein the second support member includes a plurality of support ends affixable to the recess of the support ends of the first support member.

18. The folding workbench of claim 14, wherein the support ends affixed to the first support member includes a recessed portion to be receivable to the support ends of the second support member.

19. The folding workbench of claim 14 further wherein the support ends affixed to the second support member is extended to be affixable to a recessed portion of the support ends of the first support member.
